(19) United States
(12) Patent Application Publication
(10) Pub. No.: US 2026/0204176 A1
(43) Pub. Date: Jul. 16, 2026

(54) READING SERVICE DEVICE AND METHOD FOR SUPPORTING READING ACTIVITY

(71) Applicant: PCNC Co., Ltd, Seongnam-si, Gyeonggi-do (KR)

(72) Inventors: Duck Ki KIM, Seoul (KR); So Yeon HEO, Seongnam-si, Gyeonggi-do (KR)

(21) Appl. No.: 18/867,739

(22) PCT Filed: May 20, 2024
(86) PCT No.: PCT/KR2024/006765

§ 371 Date: Nov. 20, 2024

(30) Foreign Application Priority Data
May 24, 2023 (KR) 10-2023-0067102

(51) Int. Cl. G09B 17/00; G06Q 20/10

(52) U.S. Cl. CPC G09B 17/003; G06Q 20/10

(57) ABSTRACT

Proposed is a reading service device and method for supporting a reading activity. The reading service device includes a goal setting unit, when a goal for a reading activity is set by an administrator terminal that an administrator uses, updating the set reading activity goal and providing the updated reading activity goal to a learner terminal, a monitor monitoring the reading activity that is performed by the learner terminal that a learner uses, and a rewarder performing electronic payment for a reward prize of the reading activity goal when payment related to the reward prize is requested by the administrator terminal, retaining an ownership of the reward prize when the electronic payment is completed, and transferring the retained ownership of the reward prize to the learner terminal when a learning status of the learner terminal reaches the reading active goal.

### TECHNICAL FIELD

The present disclosure relates to a reading service and, in more detail, a reading service device and method for supporting a reading activity, the device and method setting goals for learners'reading activities and giving rewards to the learners for the goals when they achieve the set goals.

### BACKGROUND ART

With the recent development of information and communication technologies, the development of information delivery technologies that provide real-time information on various fields to multiple subscribers through at least one or more host servers using long-distance data communication networks is actively underway.

These information delivery technologies are also being applied in the field of education, and there has been a recent trend of an increasing number of educational websites. However, these educational websites merely apply the content and evaluation processes of offline learning to the online environment. However, they fail to provide systematic management of the learner's reading activities and face difficulties in generating interest in reading.

### DISCLOSURE

### Technical Problem

An objective of the present disclosure is to provide a reading service device and method for supporting a reading activity, the device and method helping to foster proper reading habits by setting goals for the learners'reading activities including reading learning, reading quizzes, and post-reading activities, and by providing rewards for corresponding goals when the learners achieve the set goals.

### Technical Solution

In order to achieve the objectives, a reading service device for supporting a reading activity between an administrator terminal that an administrator uses and a learner terminal that a learner uses in accordance with the present disclosure includes: a goal setting unit, when a goal for the reading activity is set by the administrator terminal, updating the set reading activity goal and providing the updated reading activity goal to the learner terminal; a monitor monitoring the reading activity that is performed by the learner terminal; and a rewarder performing electronic payment for a reward prize of the reading activity goal when payment related to the reward prize is requested by the administrator terminal, retaining an ownership of the reward prize when the electronic payment is completed, and transferring the retained ownership of the reward prize to the learner terminal when a learning status of the learner terminal reaches the reading active goal.

Further, the goal setting unit may provide default setting of the reading activity goal on the basis of personal information of the learner, and may finally set the reading activity goal using customized setting when the default setting is changed into the customized setting suitable for the learner by the administrator terminal.

Further, the goal setting unit may calculate at least one activity pattern of an area of interest, an activity area, the amount of reading, a reading time, a post-reading activity time, and a goal achievement rate of the learner using a history of reading activities performed before by the learner terminal, and may reflect the calculated activity pattern to the default setting.

Further, the goal setting unit may calculate a level of difficulty of the reading activity goal and may recommend a reward prize suitable for the calculated level of difficulty to the administrator terminal.

Further, when a plurality of reading activity goals is set, the goal setting unit may calculate a level of difficulty for each of the reading activity goals and may recommend appropriate reward prizes to the administrator terminal in accordance with the order of the calculated levels of difficulty.

Further, when a plurality of reading activity goals is set, the monitor may monitor a reading activity for a reading activity goal that is performed by the learner terminal of the plurality of reading activity goals.

Further, the monitor may determine priority of the plurality of reading activity goals and may induce a reading activity to take place in accordance with the determined priority.

Further, when the reading activity goal is not achieved within a preset period, the rewarder may transfer the retained ownership of the reward prize to the administrator terminal or may hand over the reward prize as a reward prize for a reading activity that is performed next.

Further, when a reading activity event is generated by the administrator terminal during the reading activity, the rewarder may manage rewarding with an event prize for the reading activity event.

A reading service method that is performed by a reading service device for supporting a reading activity between an administrator terminal that an administrator uses and a learner terminal that a learner uses in accordance with the present disclosure includes: when at least one goal for the reading activity is set by the administrator terminal, updating the set reading activity goal; performing electronic payment for a reward prize of the reading activity goal when payment related to the reward prize is requested by the administrator terminal, and retaining an ownership of the reward prize when the electronic payment is completed; providing information about the updated reading activity goal and the retained reward prize to the learner terminal; monitoring the reading activity that is performed by the learner terminal; and transferring the retained ownership of the reward prize to the learner terminal when a learning status of the learner terminal reaches the reading activity goal during the monitoring.

Further, the updating may provide default setting of the reading activity goal on the basis of personal information of the learner, and may finally set the reading activity goal using customized setting when the default setting is changed into the customized setting suitable for the learner by the administrator terminal.

Further, the updating may calculate a level of difficulty of the reading activity goal and may recommend a reward prize suitable for the calculated level of difficulty to the administrator terminal.

Further, when a plurality of reading activity goals is set, the updating may calculate a level of difficulty for each of the reading activity goals and may recommend appropriate reward prizes to the administrator terminal in accordance with the order of the calculated levels of difficulty.

Further, when a plurality of reading activity goals is set, the monitoring may monitor a reading activity for a reading activity goal that is performed by the learner terminal of the plurality of reading activity goals.

Further, when the reading activity goal is not achieved within a preset period, the rewarding may transfer the retained ownership of the reward prize to the administrator terminal or may hand over the reward prize as a reward prize for a reading activity that is performed next.

### Advantageous Effects

According to an embodiment of the present disclosure, by setting a goal for a reading activity including reading learning, reading quizzes, and a post-reading activity of a learner and by providing a reward set for the goal when the learner achieves the set goal, a sense of purpose is instilled in the learner so that the learner can smoothly perform the reading activity.

It is possible to perform systematic management so that a learner can read not only books from specific areas of interest, but also various books.

Accordingly, it is possible to support a learner to have a habit of doing various reading activities by himself/herself.

### BRIEF DESCRIPTION OF DRAWINGS

FIG. 1 is a configuration diagram illustrating a reading service system according to an embodiment of the present disclosure.

FIG. 2 is a block diagram illustrating a reading service device according to an embodiment of the present disclosure.

FIG. 3 is a block diagram illustrating a controller according to an embodiment of the present disclosure.

FIG. 4 is a diagram illustrating setting of a reading activity goal according to an embodiment of the present disclosure.

FIG. 5 is a flowchart illustrating a reading service method that is performed in the reading service system according to an embodiment of the present disclosure.

FIG. 6 is a flowchart illustrating a reading service method that is performed in the reading service device according to an embodiment of the present disclosure.

FIG. 7 is a block diagram illustrating a computing device according to an embodiment of the present disclosure.

### MODE OF INVENTION

Hereafter, embodiments of the present disclosure will be described in detail with reference to the accompanying drawings so that those skilled in the art can easily accomplish the present disclosure. However, the present disclosure may be modified in various different ways and is not limited to the embodiments described herein. Further, in the accompanying drawings, components irrelevant to the description will be omitted in order to obviously describe the present disclosure, and similar reference numerals will be used to describe similar components throughout the specification.

In the specification and drawings (hereafter, “the specification”), repeated description for the same components are omitted.

Further, it is to be understood that when one element is referred to as being “connected to” or “coupled to” another element in the specification, it may be connected directly to or coupled directly to another element or be connected to or coupled to another element, having the other element intervening therebetween. On the other hand, it should be understood that when one element is referred to as being “connected directly to” or “coupled directly to” another element in the specification, it may be connected to or coupled to another element without the other element therebetween.

Further, terms used in the present disclosure are used only in order to describe specific exemplary embodiments rather than limiting the present disclosure.

Further, in the specification, singular forms are intended to include plural forms unless the context clearly indicates otherwise.

Further, it should be further understood that the terms “comprises” or “have” used in the specification specify the presence of stated features, steps, operations, components, parts, or a combination thereof, but do not preclude the presence or addition of one or more other features, numerals, steps, operations, components, parts, or a combination thereof.

Further, the term “and/or” includes a combination of a plurality of described items or any one of a plurality of described terms. In the specification, “A or B” may include all of “A”, “B”, or “A and B”.

Further, in the specification, functions and configurations that may make the subject matter of the present disclosure unclear will not be described in detail.

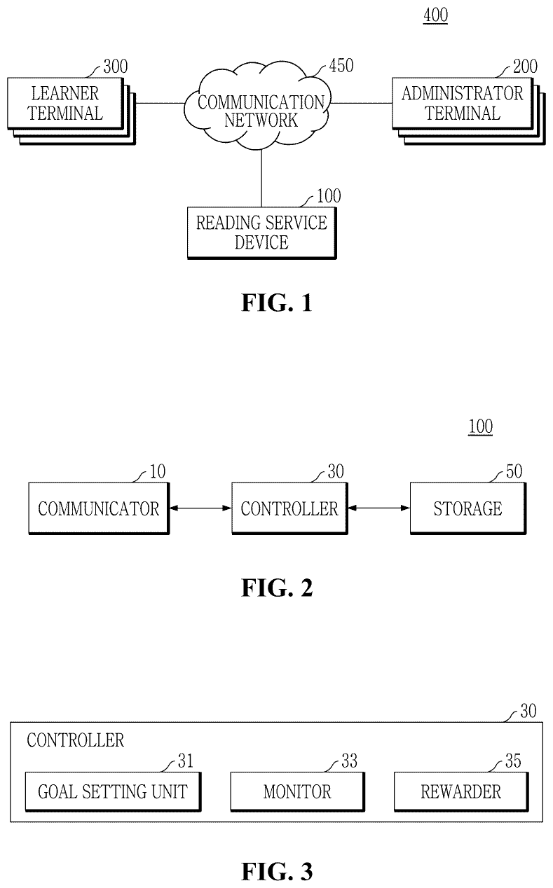

FIG. 1 is a configuration diagram illustrating a reading service system according to an embodiment of the present disclosure.

Referring to FIG. 1, a reading service system 400 helps to foster proper reading habits by setting goals for the learners'reading activities including reading, reading quizzes, and post-reading activities, and by providing rewards for corresponding goals when the learners achieve the set goals. The post-reading activities refer all of activities after reading and include writing a book review, writing reflections, writing a book evaluation writing, writing a book shelf (activity of collecting books that a learner wishes to read), creating a feedbook (activity of uploading a photo of the cover of a book that a learner has read to social network services (SNS), adding friends, etc.), a reading group activity (activity of grouping learners together to discuss (or chat) about arbitrary books), etc. To this end, the reading service system 400 includes a reading service device 100, at least one administrator terminal 200, and at least one learner terminal 300.

The reading service device 100 supports a reading activity between the administrator terminal 200 and the learner terminal 300. In this configuration, the reading service device 100 makes a reading-related service be performed in a management program that supports reading activities. When at least one goal for a reading activity is set by the administrator terminal 200, the reading service device 100 updates the set reading activity target. The reading activity goal may be target values including the type of books, the amount of reading, a reading time, a deadline for completion of reading, etc. that should be achieved during the reading activity. When a reading activity goal is set, the reading service device 100 can set information related to reward prizes for the reading activity goal, and the reading service device 100 performs an electronic payment for a corresponding reward prize when a payment request for the reward prize is made by the administrator terminal 200. In this case, the reward prizes may be mobile gift cards, points (for purchasing/receiving products through a partnership system), actual products (received via delivery), etc. The reading service device 100 retains the ownership of a reward prize when electronic payment is completed. The reading service device 100 provides the updated reading activity goal and the information about the stored reward prize to the learner terminal 300. The reading service device 100 monitors a reading activity of the learner terminal 300 that is performed on the basis of the provided information. The reading service device 100 can monitor the overall status of a reading activity and, preferably, can monitor a book type, the amount of reading, a goal achievement rate, etc. When the learning status of the learner device 300 reaches the reading activity goal during monitoring, the reading service device 100 transfers the stored ownership of the reward prize to the learner terminal 300. Further, when the learner terminal 300 fails to achieve the reading activity goal within a preset period, the reading service device 100 can transfer the stored ownership of the reward prize to the administrator terminal 200 (the terminal that processed the electronic payment). Preferably, the reading service device 100 may be a computing system for a server including a desktop, a laptop, a cluster computer, a server computer, etc.

The administrator terminal 200, which is a terminal that an administrator uses, connects to the reading service device 100 and performs setting related to reading activities and payment for rewards. In detail, the administrator terminal 200 accesses a management program of the reading service device 100 and registers for membership. When the administrator terminal 200 completes login after membership registration, the administrator terminal 200 sets a reading activity goal. In this case, the reading activity goal may be a goal that a learner (e.g., child, student, etc.) who is managed by an administrator (e.g., parent, teacher, etc.) is required to accomplish. While setting a reading activity goal, the administrator terminal 200 sets also a reward prize for the goal and requests the reading service device 100 to pay for the set reward prize such that the reading service device 100 performs electronic payment. Further, the administrator terminal 200 receives ownership-related information of the reward prize from the reading service device 100 and outputs the received information. Preferably, the administrator terminal 200 may be a personal computing system including a smartphone, a desktop, a laptop, a tablet PC, a handheld PC, etc.

The learner terminal 300, which is a terminal that a learner uses, connects to the reading service device 100, and performs a reading activity and receives a reward. In detail, the learner terminal 300 accesses the management program of the reading service device 100 and registers for membership. When completing login after membership registration, the learner terminal 300 outputs a preset reading activity goal and performs the reading activity for the output reading activity goal. In this case, when there are multiple set reading activity goals, the learner terminal 300 may select any one reading activity goal and perform one reading activity or may select multiple reading activity goals and simultaneously perform reading activities. When achieving a reading activity goal during a reading activity, the learner terminal 300 receives the transfer of ownership of a reward prize from the reading service device 100 and stores the transferred reward prize. Preferably, the learner terminal 300 may be a personal computing system including a smartphone, a desktop, a laptop, a tablet PC, a handheld PC, etc.

Meanwhile, in the reading service system 400, one or a plurality of administrator terminals 200 and one or a plurality of learner terminals 300 may provide a service in a one-to-one structure, or one or a plurality of administrator terminals 200 and a plurality of learner terminals 300 may provide a service in a one-to-many structure, but the present disclosure is not limited thereto.

Further, the reading service system 400 constructs a communication network 45 between the reading service device 100, at least one administrator terminal 200, and at least one learner terminal 300 such that the communication is made therebetween. The communication network 450 may be composed of a backbone network or a subscriber network. The backbone network may be composed of one or a plurality of integrated networks of an X.25 network, a Frame Relay network, an ATM network, a Multi-Protocol Label Switching (MPLS) network, a Generalized Multi-Protocol Label Switching (GMPLS) network, etc. The subscriber network may be Fiber To The Home (FTTH), Asymmetric Digital Subscriber Line (ADSL), a cable network, Zigbee, Bluetooth, Wireless LAN (IEEE802.11b, IEEE 802.11a, IEEE 802.11g, IEEE 802.11n), Wireless Hart(ISO/IEC 62591-1), ISA100.11a (ISO/IEC 62734), Constrained Application Protocol (CoAP), Message Queuing Telemetry Transport (MQTT), Wireless Broadband (WiBro), WiMax, 3G, High Speed Downlink Packet Access (HSDPA), 4G, 5G, 6G, etc. As some embodiments, the communication network 450 may be the internet network and may be a mobile communication network. Further, the communication network 450 may include all wireless communication and wired communication methods that are widely known or will be developed in the future.

FIG. 2 is a block diagram illustrating a reading service device according to an embodiment of the present disclosure and FIG. 3 is a block diagram illustrating a controller according to an embodiment of the present disclosure.

Referring to FIG. 1 to FIG. 3, the reading service device 100 includes a communicator 10, a controller 30, and a storage 50.

The communicator 10 communicates with at least one administrator terminal 200 and at least one learner terminal 300. The communicator 10 supports communication for the administrator terminal 200 and the learner terminal 300 to access the management program and supports communication for providing reading activity-related information.

The controller 30 generally controls the reading service device 100. The controller 30 includes a goal setting unit 31, a monitor 33, and a rewarder 35.

When at least one goal for a reading activity is set by the administrator terminal 200, the goal setting unit 31 updates the set reading activity goal and provides the updated reading activity goal to the learner terminal 300. In this case, the goal setting unit 31 provides default setting of the reading activity target to the administrator terminal 200 on the basis of the personal information (e.g., age, grade, sex, etc.) of the learner. The goal setting unit 31 can calculate at least one activity pattern of the area of interest, an activity area, the amount of reading, a reading time, a post-reading activity time, and a goal achievement rate of a learner using the history of the reading activities performed before by the learner terminal 300, and can reflect the calculated activity pattern to the default setting. Accordingly, when a learner is a learner who performed a reading activity before, the default setting can be automatically set to setting optimized for the learner. The goal setting unit 31 can change the provided default setting into customized setting for the learner through the administrator terminal, whereby it is possible to finally set a reading activity goal. That is, the goal setting unit 31 can set a reading activity goal according to the level of each learner or can set a reading activity goal according to the level desired by the administrator.

Further, the goal setting unit 31 calculates the difficulty level of the reading activity goal and recommends a reward prize suitable for the calculated difficulty level to the administrator terminal 200. Preferably, the higher the difficulty level of a reading activity goal, the higher the value of a prize that the goal setting unit 31 can recommend as a reward prize. The goal setting unit 31 can calculate a difficulty level by considering factors such as the learner's personal information, the type of book, the number of words in the book, the presence of illustrations, and the level of terminologies. In this case, the goal setting unit 31 can quantify a difficulty level for each factor and calculate the difficulty of level on the basis of the sum of the quantified results. For example, the goal setting unit 31 can calculate a difficulty level in a way that the level increases as the magnitude of the sum increases, and preferably, can calculate a difficulty level in stages of 1~N, but the present disclosure is not limited thereto. When a plurality of reading activity goals is set, the goal setting unit 31 can calculate a difficulty level for each of the reading activity goals. The goal setting unit 31 can recommend appropriate reward prizes to the administrator terminal 200 in accordance with the order of the calculated difficulty levels. In this case, the goal setting unit 31 only recommends reward prizes to the administrator terminal 200 and the final setting for the reward prizes can be determined by the administrator terminal 200.

The monitor 33 monitors a reading activity that is performed by the learner terminal 300. The monitor 33 can monitor the overall status of a reading activity and, preferably, can monitor a book type, the amount of reading, a goal achievement rate, etc. In this case, when a plurality of reading activity goals is set, the learner terminal 300 can select at least one of the plurality of reading activity goals and perform a reading activity for the selected reading activity goal. Accordingly, when a plurality of reading activity goals is set, the monitor 33 can monitor the reading activity for the reading activity goal that is performed by the learner terminal 300 of the plurality of reading activity goals. In this case, the monitor 33 determines the priority of a plurality of reading activities. When a reading activity goal is set by the administrator terminal 200, the monitor 33 can determine priority on the basis of weights set in accordance with importance. In this case, the importance refers to a reading method that is prioritized. That is, the importance refers to a reading method that the administrator prioritizes for the learner. The reading method may include careful reading, speed reading, comprehensive reading, extensive reading, etc.

When a reading activity event is generated by the administrator terminal 200 during a reading activity, the monitor 33 provides support to ensure that the reading activity event is performed as a priority. That is, the monitor 33 temporarily suspends the currently ongoing reading activity and provides information required to perform the reading activity to the learner terminal 300. In this case, the monitor 33 can provide information to the learner terminal 300 through a pop-up window, a notification signal, etc. The reading activity event may include a reading quiz, writing a book review, writing reflections, writing a book evaluation, etc.

When payment for a reward prize of a reading activity goal is requested by the administrator terminal 200, the rewarder 35 performs electronic payment for the reward prize. The electronic payment may be various types of well-known payment methods. Further, the rewarder 45, as described above, does not match a reward prize with each reading activity goal, but instead may provide reward prizes through a fixed rate system on a monthly or annual basis. The rewarder 35 retains the ownership of a reward prize when electronic payment is completed. When the learning status of the learner terminal 3000 reaches a reading activity goal during monitoring, the rewarder 35, while monitoring, provides a notification signal indicating that the learner terminal 300 has reached reading activity goal to both the administrator terminal 20 and the learner terminal 300.

Further, the rewarder 35 transfers the retained ownership of the prize to the learner terminal 300, and when transfer of the ownership is completed, the rewarder 35 provides a notification signal indicating that transfer of the ownership is completed. When the reading activity goal is not achieved within a goal time that is a preset period, the rewarder 35 may transfer the retained ownership of the reward prize to the administrator terminal 200 or may hand over the reward prize as the reward product for the next reading activity.

In this case, when a reading activity event is generated by the administrator terminal 200 during a reading activity, the rewarder 35 manages rewarding with an event prize for the reading activity event. That is, the rewarder 35 performs electronic payment for the event prize corresponding to the reading activity event, and retains the ownership of the event prize when electronic payment is completed. When the reading activity event is completed by the learner terminal 300, the rewarder 35 transfers the retained ownership of the event prize to the learner terminal 300. Further, when the reading activity event by the learner terminal 300 is not completed, the rewarder 35 may transfer the retained ownership of the event prize to the administrator terminal 200 or may hand over the event prize as an event prize for the next reading activity event.

The storage 50 stores a program or an algorithm for driving the reading service device 100. The storage 50 stores member information about the administrator and the learner and stores information about a reading activity goal and a reading activity event. Further, the storage 50 stores information about a reward prize and an event prize and stores information about monitoring. The storage 50 may include at least one storage medium of flash memory type, hard disk type, media card micro type, and card type memories (e.g., an SD or XD memory), a RAM (Random Access Memory) an SRAM (Static Random Access Memory), a ROM (Read-Only Memory), an EEPROM (Electrically Erasable Programmable Read-Only Memory), a PROM (Programmable Read-Only Memory), a magnetic memory, a magnetic disc, and an optical disc.

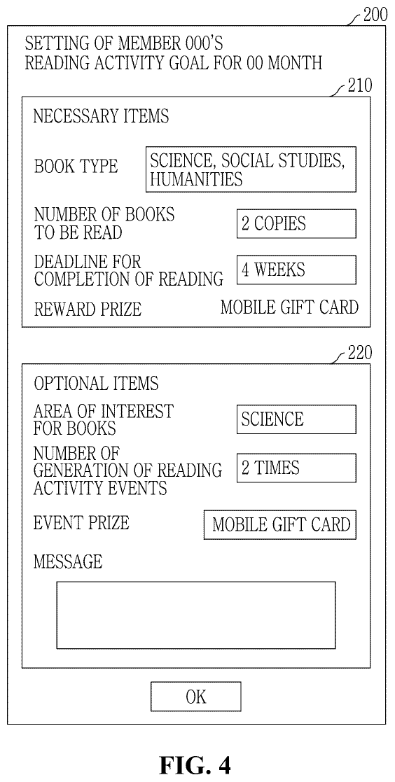

FIG. 4 is a diagram illustrating setting of a reading activity goal according to an embodiment of the present disclosure.

Referring to FIG. 4, the administrator terminal 200 connects to the reading service device 100 and then performs a reading-related service in the administration program supported by the reading service device 100. In this case, the administrator terminal 200 can set a reading activity goal in a corresponding month for a specific member through the administration program.

The administrator terminal 200 can set a reading activity goal separately in a necessary item menu 210 and an optional item menu 220.

The necessary item menu 210 can set a book type, the number of books to be read, a deadline for completion of reading, a reward prize, etc. In this case, the administration program can provide default setting on the basis of the personal information of a specific member and can perform final setting for the necessary items by changing the default setting to correspond to the situation by the administrator. The necessary item menu 210 supports a learner to access various books by selecting a plurality of book types. Further, the necessary item menu 210 can select and set a mobile gift card (the amount of money can be set), points of a partnership system (points can be set), an actual product, etc. as a reward prize.

The optional item menu 220 can set the area of interest for books, the number of generation of reading activity events, an event prize, a message, etc. The optional item menu 220 specifies the area of interest for books and gives a weight, thereby give support such that the setting can be used later when selecting priorities. The optional item menu 220 can set an event prize for each reading activity event or can set an event prize for all of reading activity events. Further, the optional item menu 220 supports the administrator to transmit detailed requests to a learner through a message.

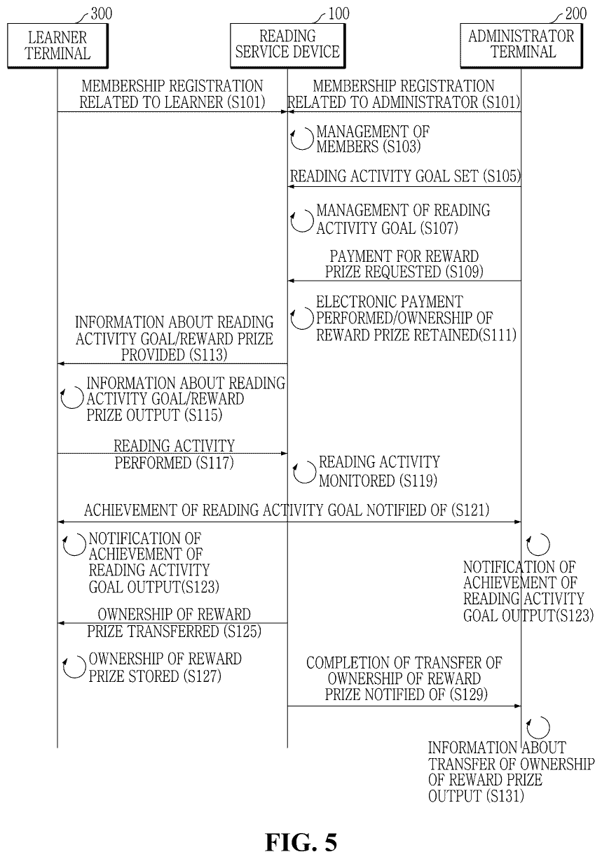

FIG. 5 is a flowchart illustrating a reading service method that is performed in the reading service system according to an embodiment of the present disclosure.

Referring to FIG. 5, the reading service method sets a goal for a reading activity including reading learning, reading quizzes, and a post-reading activity of a learner and provides a reward set for the goal when the learner achieves the set goal, thereby instilling a sense of purpose in the learner so that the learner can smoothly perform the reading activity. The reading service method can perform systematic management so that a learner can read not only books from specific areas of interest, but also various books.

In step S101, the administrator terminal 200 and the learner terminal 300 register for membership. The administrator terminal 200 performs membership registration for the administrator in the administration program. The learner terminal 200 performs membership registration for the learner in the administration program. In this case, the administrator terminal 200 and the learner terminal 300 can log in and can perform a reading service through the administration program in the login state.

In step S103, the reading service device 100 manages information about the registered members (administrator and learner). The reading service device 100 updates information about a new registered member.

In step S105, the administrator terminal 200 sets a reading activity goal. The administrator terminal 200 sets a goal for a reading activity on the administration program. The reading activity goal may be target values including the type of books, the amount of reading, a reading time, a deadline for completion of reading, etc. that should be achieved during the reading activity.

In step S107, the reading service device 100 manages information about the set reading activity goal. The reading service device 100 updates information about a new set reading activity goal.

In step S109, the administrator terminal 200 requests payment related to a reward prize. The administrator terminal 200 enables the reading service device 100 to perform electronic payment by requesting the reading service device 100 to pay for the reward prize for the set reading activity goal.

In step S111, the reading service device 100 performs electronic payment and retains the ownership of the reward prize. The reading service device 100 performs electronic payment for the reward prize using a known electronic payment system. The reading service device 100 retains the ownership of the reward prize in the system when electronic payment is completed.

In step S113, the reading service device 100 provides information about the reading activity goal and the reward prize to the learner terminal 300.

In step S115, the learner terminal 300 outputs the information about the reading activity goal and the reward prize. Accordingly, the learner checks the goal of the reading activity and checks the reward prize that the learner receives when achieving the checked goal, whereby it is possible to increase an interest in a reading activity.

In step S117, the learner terminal 300 performs the reading activity. The learner terminal 300 performs the reading activity on the administration program.

In step S119, the reading service device 100 performs monitoring related to the reading activity. The reading service device 100 monitors the reading activity that is performed by the learner terminal 300. In this case, the reading service device 100 updates in real time the history about the reading activity such as the area of interest, an activity area, the amount of reading, a reading time, a post-reading activity time, and a goal achievement rate of the learner. The area of interest means the area that a leaner has an interest in, the activity area means the area of activities that the learner performed before, the amount of reading means the amount of the books that the learner read (e.g., the unit of copy), the post-reading activity time means the time that the learner used in the activities that the learner performed after reading, and the a goal achievement rate the percentage that represents the activities that the learner has performed so far in order to achieve the reading activity goal.

In step S121, when the learner terminal 300 achieves the reading activity goal, the reading service device 100 informs the administrator terminal 200 and the learner terminal 300 that the goal has been achieved.

In step S123, the administrator terminal 200 and the learner terminal 300 each output a notification of the achievement of the reading activity goal. In this case, the administrator terminal 200 and the learner terminal 300 each can output the matter through a pop-up window, a notification signal, etc.

In step S125, the reading service device 100 transfers the ownership of the retained reward prize to the learner terminal 300. The reading service device 100 transfers the ownership of the reward prize so that the learner can use the reward prize.

In step S127, the learner terminal 300 stores the transferred ownership of the reward prize. In this case, the learner terminal 300 can store the ownership in the types of a barcode, a QR code, point accumulation, etc.

In step S129, the reading service device 100 informs the administrator terminal 200 that transfer of the ownership of the reward prize has been completed.

In step S131, the administrator terminal 200 outputs information about the transfer of the ownership of the reward prize. The administrator terminal 200 can output the matter through a pop-up window, a notification signal, etc.

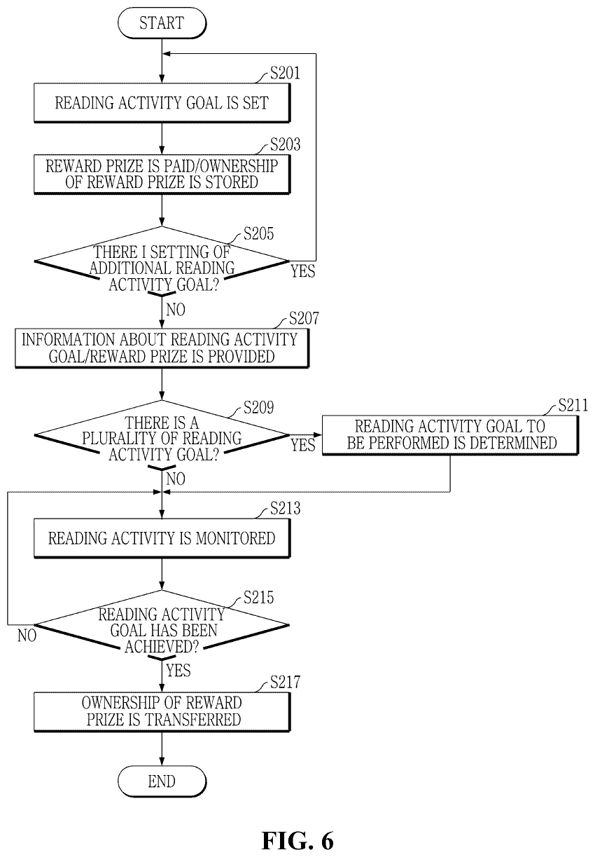

FIG. 6 is a flowchart illustrating a reading service method that is performed in the reading service device according to an embodiment of the present disclosure.

Referring to FIG. 5 and FIG. 6, the reading service method induces a learner to be able to perform a reading activity in accordance with a reading activity goal set by an administrator, thereby supporting development of reading habits in the learner.

In step S201, a reading activity goal is set in the reading service device 100. The reading activity goal is set in the reading service device 100 by the administrator terminal 200.

In step S203, the reading service device 100 performs electronic payment for a reward prize and retains the ownership of the reward prize. When receiving a request for payment for the reward prize from the administrator terminal 200, the reading service device 100 performs electronic payment for the request. Further, when completing the electronic payment, the reading service device 100 retains the ownership of the reward prize.

In step S205, the reading service device 100 determines whether there is setting of additional activity goals... When there is setting of an additional reading activity performed by the administrator terminal 200, the reading service device 100 goes back to step S201, and if not, the reading service device 100 performs step S207.

In step S207, the reading service device 100 provides information about the set reading activity goal and the paid reward prize to the learner terminal 300.

In step S209, the reading service device 100 determines whether there is a plurality of reading activity goals. When there is a plurality of reading activity goals, the reading service device 100 performs step S211, and when it is one rather than multiple, the reading service device 100 performs step S213.

In step S211, a reading activity goal to be performed is determined in the reading service device 100. At least one of a plurality of reading activity goals is determined in the reading service device 100 by the learner terminal 200.

In step S213, the reading service device 100 monitors the reading activity. The reading service device 100 monitors in real time the reading activity that is performed by the learner terminal 200.

In step S215, the reading service device 100 determines whether the reading activity goal has been achieved. When the reading activity goal has been achieved, the reading service device 100 performs step S217, and if not, the reading service device 100 goes back to step S213.

In step S217, the reading service device 100 transfers the ownership of a reward prize. The reading service device 100 transfers the retained ownership of the reward prize to the learner terminal 300 and informs the administrator terminal 200 of this matter.

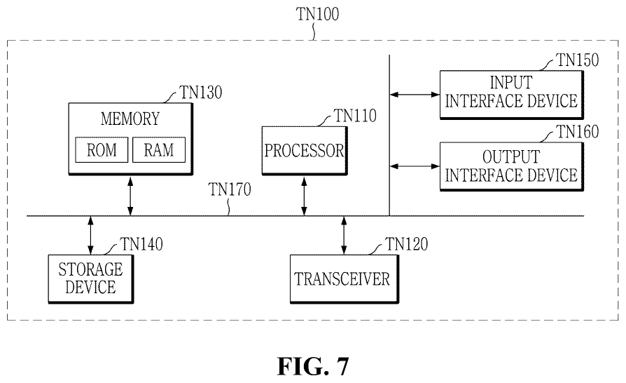

FIG. 7 is a block diagram illustrating a computing device according to an embodiment of the present disclosure.

Referring to FIG. 7, a computing device TN100 may be a device described in the specification (e.g., the reading service device, the administrator terminal, the learner terminal, etc.).

The computing device TN100 may include at least one processor TN110, transceiver TN120, and memory TN130. Further, the computing device TN100 may further include a storage device TN140, an input interface device TN 150, an output interface device TN160, etc. The components included in the computing device TN100 are connected by a bus TN170, whereby they can communicate with each other.

The processor TN110 can execute program commands stored in at least one of the memory TN130 and the storage device TN140. The processor TN110 may mean a central processing unit (CPU), a graphics processing unit (GPU), or an exclusive processor that performs the methods according to embodiments of the present disclosure. The processor TN110 may be configured to implement the procedures, functions, methods, etc. described in relation to embodiments of the present disclosure. The processor TN110 can control the components of the computing device TN100.

The memory TN130 and the storage device TN140 each can store various pieces of information related to the operation of the processor TN110. The memory TN130 and the storage device TN140 each may be at least one of a volatile storage medium and a nonvolatile storage medium. For example, the memory TN130 may be at least one of a read only memory (ROM) and a random access memory (RAM).

The transceiver TN120 can transmit or receive wired signals or wireless signals. The transceiver TN120 is connected to a network, thereby being able to perform communication.

Meanwhile, embodiments of the present disclosure are implemented only through the devices and/or methods described above and may be implemented through programs that implement functions corresponding to the configuration of the embodiments of the present disclosure or a recording medium in which the programs are recorded, and the present disclosure may be easily implemented by those skilled in the art.

Although embodiments of the present disclosure were described above in detail, the spirit of the present disclosure is not limited thereto and the present disclosure may be changed and modified in various ways on the basis of the basic concept without departing from the scope of the present disclosure described in the following claims.

1. A reading service device for supporting a reading activity between an administrator terminal that an administrator uses and a learner terminal that a learner uses, the reading service device comprising:
a goal setting unit, when a goal for the reading activity is set by the administrator terminal, updating the set reading activity goal and providing the updated reading activity goal to the learner terminal;
a monitor monitoring the reading activity that is performed by the learner terminal; and
a rewarder performing electronic payment for a reward prize of the reading activity goal when payment related to the reward prize is requested by the administrator terminal, retaining an ownership of the reward prize when the electronic payment is completed, and transferring the retained ownership of the reward prize to the learner terminal when a learning status of the learner terminal reaches the reading active goal.

2. The reading service device of claim 1, wherein the goal setting unit provides default setting of the reading activity goal on the basis of personal information of the learner, and finally sets the reading activity goal using customized setting when the default setting is changed into the customized setting suitable for the learner by the administrator terminal.

3. The reading service device of claim 2, wherein the goal setting unit calculates at least one activity pattern of an area of interest, an activity area, the amount of reading, a reading time, a post-reading activity time, and a goal achievement rate of the learner using a history of reading activities performed before by the learner terminal, and reflects the calculated activity pattern to the default setting.

4. The reading service device of claim 1, wherein the goal setting unit calculates a level of difficulty of the reading activity goal and recommends a reward prize suitable for the calculated level of difficulty to the administrator terminal.

5. The reading service device of claim 1, wherein when a plurality of reading activity goals is set, the goal setting unit calculates a level of difficulty for each of the reading activity goals and recommends appropriate reward prizes to the administrator terminal in accordance with the order of the calculated levels of difficulty.

6. The reading service device of claim 1, wherein when a plurality of reading activity goals is set, the monitor monitors a reading activity for a reading activity goal that is performed by the learner terminal of the plurality of reading activity goals.

7. The reading service device of claim 6, wherein the monitor determines priority of the plurality of reading activity goals and induces a reading activity to take place in accordance with the determined priority.

8. The reading service device of claim 1, wherein when the reading activity goal is not achieved within a preset period, the rewarder transfers the retained ownership of the reward prize to the administrator terminal or hands over the reward prize as a reward prize for a reading activity that is performed next.

9. The reading service device of claim 1, wherein when a reading activity event is generated by the administrator terminal during the reading activity, the rewarder manages rewarding with an event prize for the reading activity event.

10. A reading service method that is performed by a reading service device for supporting a reading activity between an administrator terminal that an administrator uses and a learner terminal that a learner uses, the reading service method comprising:
when at least one goal for the reading activity is set by the administrator terminal, updating the set reading activity goal;
performing electronic payment for a reward prize of the reading activity goal when payment related to the reward prize is requested by the administrator terminal, and retaining an ownership of the reward prize when the electronic payment is completed;
providing information about the updated reading activity goal and the retained reward prize to the learner terminal;
monitoring the reading activity that is performed by the learner terminal; and
transferring the retained ownership of the reward prize to the learner terminal when a learning status of the learner terminal reaches the reading activity goal during the monitoring.

11. The reading service method of claim 10, wherein the updating provides default setting of the reading activity goal on the basis of personal information of the learner, and finally sets the reading activity goal using customized setting when the default setting is changed into the customized setting suitable for the learner by the administrator terminal.

12. The reading service method of claim 10, wherein the updating calculates a level of difficulty of the reading activity goal and recommends a reward prize suitable for the calculated level of difficulty to the administrator terminal.

13. The reading service method of claim 10, wherein when a plurality of reading activity goals is set, the updating calculates a level of difficulty for each of the reading activity goals and recommends appropriate reward prizes to the administrator terminal in accordance with the order of the calculated levels of difficulty.

14. The reading service method of claim 10, wherein when a plurality of reading activity goals is set, the monitoring monitors a reading activity for a reading activity goal that is performed by the learner terminal of the plurality of reading activity goals.

15. The reading service method of claim 10, wherein when the reading activity goal is not achieved within a preset period, the transferring transfers the retained ownership of the reward prize to the administrator terminal or hands over the reward prize as a reward prize for a reading activity that is performed next.
